(19) United States
(12) Patent Application Publication
(10) Pub. No.: US 2009/0254679 A1
(43) Pub. Date: Oct. 8, 2009

(54) CONNECTION APPARATUS AND METHOD FOR LIMITING SIGNAL TRANSFER

(75) Inventor: Kensuke Yasuma, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/412,714

(22) Filed: Mar. 27, 2009

(30) Foreign Application Priority Data
Apr. 2, 2008 (JP) 2008-096292

(51) Int. Cl. G06F 15/16

(52) U.S. Cl. 709/249

(57) ABSTRACT

A connection apparatus that is connected to a first network obtains function information from an apparatus that exists in the first network, and limits signal transfer between the first network and a second network in accordance with destination information included in the obtained function information.

### BACKGROUND OF THE INVENTION

1. Field of the Invention

The present invention relates to a connection apparatus and a method for limiting signal transfer.

2. Description of the Related Art

A technology capable of using service without any complicated operation or setting simply by connecting an apparatus to a network, such as universal plug and play (UPnP), is known. When UPnP is used, simply connecting an apparatus to a network allows other apparatuses to control the apparatus. Thus, a method for limiting access was necessary.

In the related art, filtering using a media access control (MAC) address is known as the method for limiting access via a network. Furthermore, filtering using an internet protocol (IP) address and a port number is also known.

A technology in which an apparatus that performs a sequence according to a UPnP protocol is registered, and in which access to the other apparatuses is limited is known as a technology that is provided using a combination of UPnP and filtering (for example, see US Patent Application Publication No. 2006/253852).

Additionally, a technology is known, in which a policy is obtained from a user or a server, and in which access to an apparatus that does not satisfy the policy is limited (for example, see US Patent Application Publication No. 2006/136987).

However, a problem occurs particularly when two or more types of UPnP devices (functions), such as a media server and a media renderer, exist in the same apparatus. In other words, when access to a media server is desired to be limited although access to a media renderer is desired to be permitted, there is a problem that access to the media renderer is also limited.

### SUMMARY OF THE INVENTION

The present invention provides an apparatus and method that can limit access on a function-by-function basis.

According to an aspect of the present invention, there is provided a connection apparatus that is connected to a first network. The connection apparatus includes a transfer section configured to transfer a signal between the first network and a second network; an obtaining section configured to obtain function information from an apparatus that exists in the first network; and a limiting section configured to limit signal transfer between the first network and the second network in accordance with destination information that is included in the function information which has been obtained by the obtaining section.

According to another aspect of the present invention, there is provided a method for limiting signal transfer using a connection apparatus that is connected to a first network. The method includes obtaining function information from an apparatus that exists in the first network; and limiting signal transfer between the first network and a second network in accordance with destination information that is included in the obtained function information.

Further, according to another aspect of the present invention, a computer readable storage medium is provided containing computer-executable instructions for a connection apparatus that is connected to a first network. The medium includes computer-executable instructions that obtain function information from an apparatus that exists in the first network; and computer-executable instructions that limit signal transfer between the first network and a second network in accordance with destination information that is included in the obtained function information.

Further features of the present invention will become apparent from the following description of exemplary embodiments.

### BRIEF DESCRIPTION OF THE DRAWINGS

FIG. 1 is a diagram of a configuration of a network system according to an embodiment of the present invention.

FIG. 2 is a diagram of a configuration of a logical-network control apparatus.

FIG. 3 is a diagram of a module configuration of the logical-network control apparatus.

FIG. 4 is a flowchart illustrating a process that is performed in a case in which the logical-network control apparatus has accepted a logical-network connection request.

FIG. 5 is an illustration showing a configuration of an m-search that is sent from a filter control section.

FIG. 6 is an illustration showing an example of a corresponding m-search response that the filter control section receives.

FIG. 7 is an illustration showing an example of a device description that a filter-information generating section obtains.

FIG. 8 is an illustration showing an example of filter information that the filter-information generating section generated.

FIG. 9 is a flowchart illustrating a process that is performed in a case in which the logical-network control apparatus has received a simple service discovery protocol (SSDP) message (advertisement information).

FIG. 10 is an illustration showing an example of an alive SSDP message.

FIG. 11 is an illustration showing an example of a byebye SSDP message.

FIG. 12 is a flowchart illustrating a process that is performed while a process that started when the filter control section was activated is continuing.

### DESCRIPTION OF THE EMBODIMENTS

Exemplary embodiments of the present invention will be described below in detail with reference to the accompanying drawings.

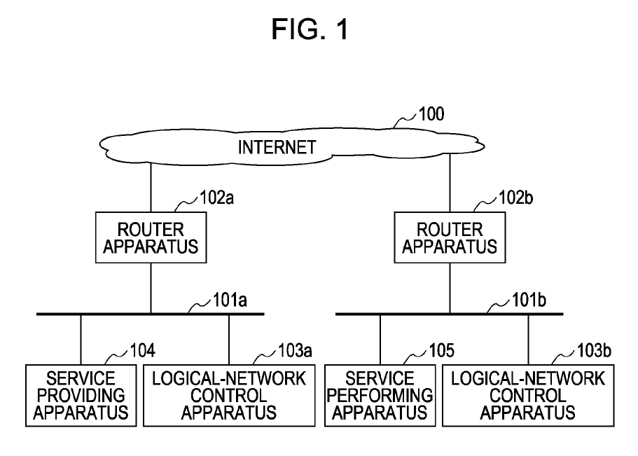

FIG. 1 is a diagram of a configuration of a network system according to an embodiment of the present invention. Referring to FIG. 1, reference numeral 100 denotes the Internet. Here, although the Internet 100 is shown as an example, a wide area network (WAN), a local area network (LAN), or a line that is configured using a combination of the WAN and the LAN may alternatively be used.

Reference numerals 101a and 101b denote home LANs. Here, although the LANs are shown as examples, a line that is configured using a combination of Ethernet® which is a LAN and Bluetooth may alternatively be used.

Reference numerals 102a and 102b denote router apparatuses. The router apparatus 102a connects the Internet 100 and the LAN 101a, and performs packet transfer and path control. The router apparatus 102b connects the Internet 100 and the LAN 101b, and performs packet transfer and path control.

Reference numerals 103a and 103b denote logical-network control apparatuses. The logical-network control apparatus 103a is connected to the LAN 101a, and performs virtual private network (VPN) connection in Layer 2 (a data link layer). The logical-network control apparatus 103b is connected to the LAN 101b, and performs VPN connection in Layer 2 (a data link layer).

Reference numeral 104 denotes a service providing apparatus having two UPnP devices, a media server and a media renderer. The service providing apparatus 104 is connected to the LAN 101a, and releases two services (functions), the media server and the media renderer, on the LAN 101a.

Reference numeral 105 denotes a service performing apparatus having two UPnP control points, a media server and a media renderer. The service performing apparatus 105 is connected to the LAN 101b, and can search and control a media server and a media renderer that are connected on the LAN 101b.

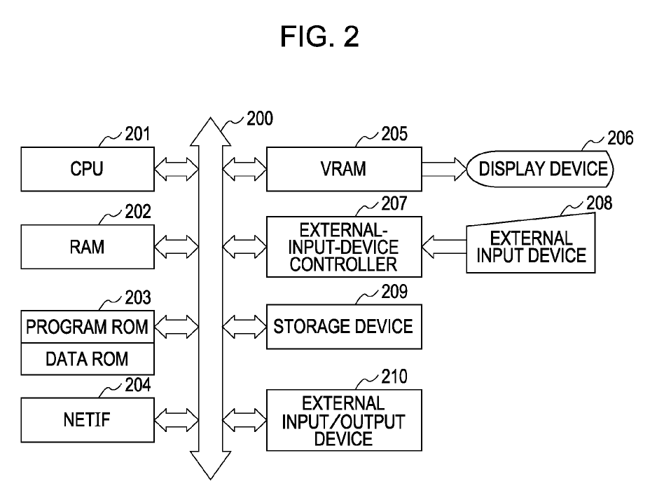

FIG. 2 is a diagram showing a circuit configuration of each of the logical-network control apparatuses 103a and 103b. The logical-network control apparatuses 103a and 103b are configured using computers such as workstations, notebook personal computers (PCs), or palmtop PCs. Furthermore, the logical-network control apparatuses 103a and 103b may be configured using various types of household electric appliances, such as televisions in which computers are embedded, or using terminals having a communication function for communication with other network control apparatuses that include game machines having a communication function, mobile phones, and personal handy-phone systems (PHSs), and so forth. Alternatively, the logical-network control apparatuses 103a and 103b may be configured using a combination of the above-mentioned devices.

Reference numeral 201 denotes a central processing unit (CPU) that controls a computer system.

Reference numeral 202 denotes a random-access memory (RAM). The RAM 202 is the main memory of the CPU 201, and serves as an area in which an execution program is stored, an area in which a process is performed using the execution program, or an area in which data that is necessary for the process is stored.

Reference numeral 203 denotes a read-only memory (ROM) in which a procedure for processing operations of the CPU 201 is recorded. The ROM 203 includes a program ROM, in which an operation system (OS) that is a system program for controlling devices of the computer system is recorded, and a data ROM, in which information that is necessary in order to cause the computer system to operate or the like is recorded. A storage device 209, which is described below, may be used instead of the ROM 203.

Reference numeral 204 denotes a network interface (hereinafter, referred to as a “NETIF”). The NETIF 204 performs, via a network, control for transferring data between computer systems and diagnostics to determine a connection state.

Reference numeral 205 denotes a video RAM (VRAM). An image that shows an operating state of the computer system and that is to be displayed on a screen of a display device 206, which is described below, is loaded into the VRAM 205, and the VRAM 205 performs control of displaying the image. The display device 206 is a display device, and is configured using a display such as a cathode-ray tube (CRT).

Reference numeral 207 denotes an external-input-device controller that controls an input signal which is supplied from an external input device 208, which is described below. The external input device 208 is an external input device for accepting an operation that is to be performed for the computer system by a user who uses the computer system, and is configured using, for example, a keyboard.

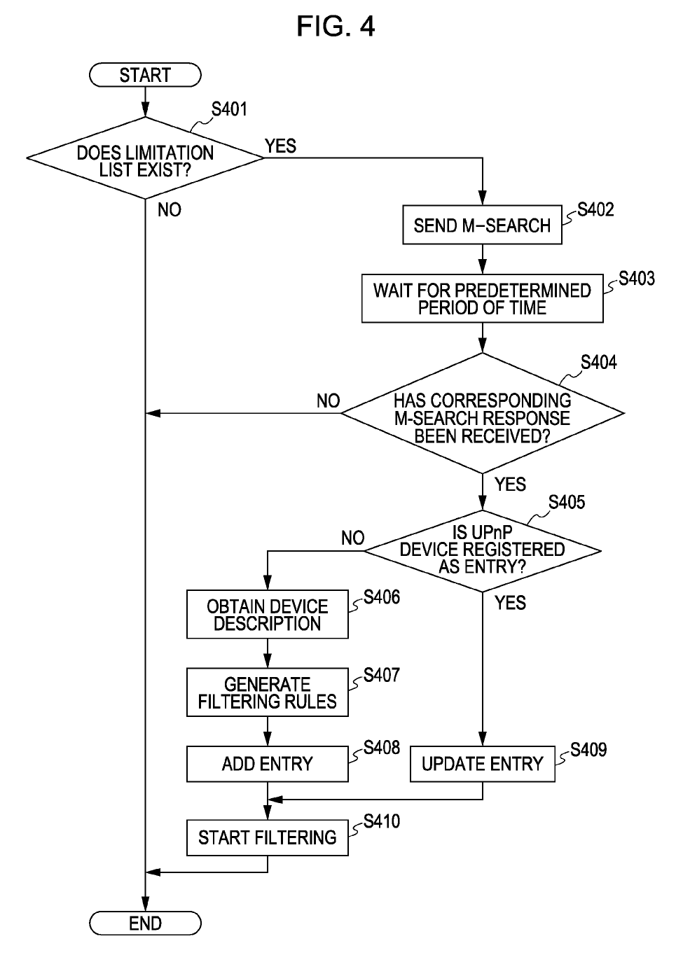

Reference numeral 209 denotes a storage device. The storage device 209 is configured using, for example, a hard disk. The storage device 209 is used to store an application program or data such as image information. The application program in this embodiment is a program for performing processes illustrated in FIGS. 4, 9, and 12, or the like.

Reference numeral 210 denotes an external input/output device. The external input/output device 210 controls inputting or outputting of data or a program from/to a removable medium that is detachably attached, such as a flexible disk drive (FDD) or a compact disk read-only memory (CD-ROM) drive.

Note that the application program or data that is stored in the storage device 209 may be stored in the removable medium, and that the application program or data can be input from the external input/output device 210 and used.

Reference numeral 200 denotes an input/output bus (including an address bus, a data bus, and a control bus) for connecting the above-described sections to each other.

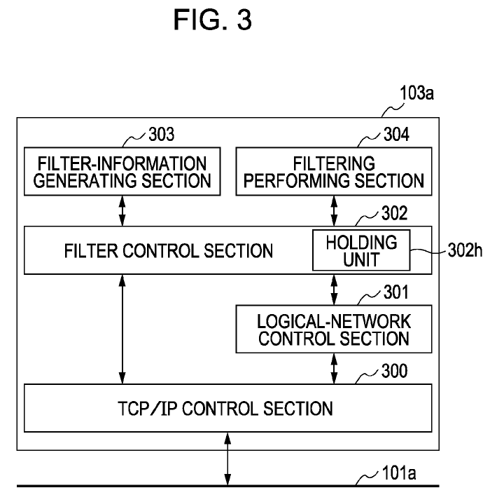

FIG. 3 is a diagram of a function module configuration of the logical-network control apparatus 103a according to this embodiment.

Reference numeral 300 denotes a transmission control protocol/internet protocol (TCP/IP) control section that is connected to the LAN 101a, and that performs a communication process using a TCP/IP.

Reference numeral 301 denotes a logical-network control section that performs a process of receiving and sending communication data for the TCP/IP control section 300, and that controls performance of processes of connection and disconnection of a logical network or the like. The logical-network control section 301 requests a filter control section 302, which is described below, to perform a process of adding or removing a filter or the like.

Reference numeral 302 denotes a filter control section that controls a filter. The filter control section 302 performs communication using a simple service discovery protocol (SSDP) via the TCP/IP control section 300. When the logical-network control section 301 requests the filter control section 302 to perform the process of adding a filter, the filter control section 302 requests a filter-information generating section 303, which is described below, to generate filter information in accordance with a filter identification (ID) that is included in a limitation list which the filter control section 302 holds. UUIDs of UPnP devices, which serve as filter IDs, device types, UPnP device names, and so forth are described in the limitation list in which UPnP devices to which access limitations are to be imposed are listed. A holding unit 302h holds the limitation list. Furthermore, the filter control section 302 sends the filter information that is generated by the filter-information generating section 303 to a filtering performing section 304, and requests the filtering performing section 304 to perform filtering.

Reference numeral 303 denotes a filter-information generating section that generates filter information which is used when packets are to be transferred from a physical network to a logical network. The filter-information generating section 303 accepts a request to generate filter information from the filter control section 302. After the filter-information generating section 303 generates filter information in accordance to the limitation list, the filter-information generating section 303 sends the generated filter information to the filter control section 302.

Reference numeral 304 denotes a filtering performing section that performs filtering in accordance with the filter information, which has been generated by the filter-information generating section 303 and passed from the filter control section 302. When packets are to be transferred from a physical network to a logical network, the filtering performing section 304 limits packet transfer in accordance with the filter information.

The logical-network control apparatus 103a accepts a logical-network connection request from the logical-network control apparatus 103b. When the logical-network control apparatus 103a accepts the logical-network connection request, the logical-network control apparatus 103a configures a logical network between the logical-network control apparatus 103a and the logical-network control apparatus 103b. The logical network in this embodiment uses Layer 2 tunneling, and the LAN 101a and the LAN 101b are configured as a single link. Accordingly, the logical-network control apparatus 103b that is provided on the LAN 101b can find and control a UPnP device that is provided on the LAN 101a.

FIG. 4 is a flowchart illustrating a process that is performed in a case in which the logical-network control apparatus 103a has accepted the logical-network connection request from the logical-network control apparatus 103b.

When the logical-network control section 301 accepts the logical-network connection request from the logical-network control apparatus 103b via the TCP/IP control section 300, the logical-network control section 301 requests the filter control section 302 to perform the process of adding a filter, whereby the process illustrated in the flowchart shown in FIG. 4 starts.

In step S401, the filter control section 302 determines whether or not it has the limitation list (the list in which device names of UPnP devices to which access limitations are to be imposed or the like are listed) in the holding unit 302h. When the filter control section 302 has the limitation list, the filter control section 302 requests the filter-information generating section 303 to generate filter information, and the process proceeds to step S402. When the filter control section 302 does not have the limitation list, the process ends.

In step S402, the filter control section 302 sends, via the TCP/IP control section 300 to the LAN 101a, an m-search using a UPnP device name that is included in the limitation list, and the process proceeds to step S403.

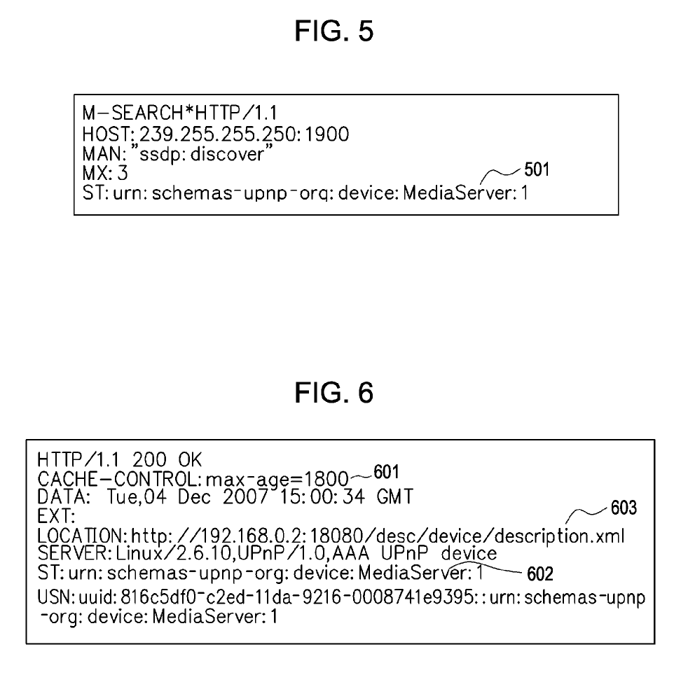

FIG. 5 is an illustration showing a configuration of the m-search that is sent from the filter control section 302. As shown in FIG. 5, it is supposed that “Media Server 501” is described as a UPnP device (function) name in the m-search.

When a corresponding media server on the service providing apparatus 104 receives the m-search, the media server sends an m-search response to the logical-network control apparatus 103a.

In step S403, after the filter control section 302 has sent the m-search, the filter control section 302 waits for a predetermined period of time (a time shown as an MX value that is attached to the m-search), and the process proceeds to step S404.

In step S404, the filter control section 302 determines whether or not the filter control section 302 has received the corresponding m-search response.

When the filter control section 302 has received the corresponding m-search response, the process proceeds to step S405. In contrast, when the filter control section 302 has not received the corresponding m-search response, the process ends. FIG. 6 is an illustration showing an example of the corresponding m-search response that the filter control section 302 receives. As shown in FIG. 6, “Media Server 602” is described as a UPnP device name in the m-search response.

In step S405, the filter control section 302 determines whether or not a UPnP device (a media server) whose name is described in the m-search response has been registered as an entry in the filter information.

When it is determined that the UPnP device (the media server) has been registered as an entry, the process proceeds to step S409. In contrast, when it is determined that the UPnP device (the media server) has not been registered as an entry, the filter control section 302 sends information included in the m-search response to the filter-information generating section 303, and the process proceeds to step S406.

In step S406, the filter-information generating section 303 obtains a LOCATION value 603 from the information included in the m-search response. The LOCATION value 603 indicates a uniform resource locator (URL) of a device description (device information) of a UPnP root device. The filter-information generating section 303 obtains the device description that is given at the URL via the TCP/IP control section 300, and the process proceeds to step S407.

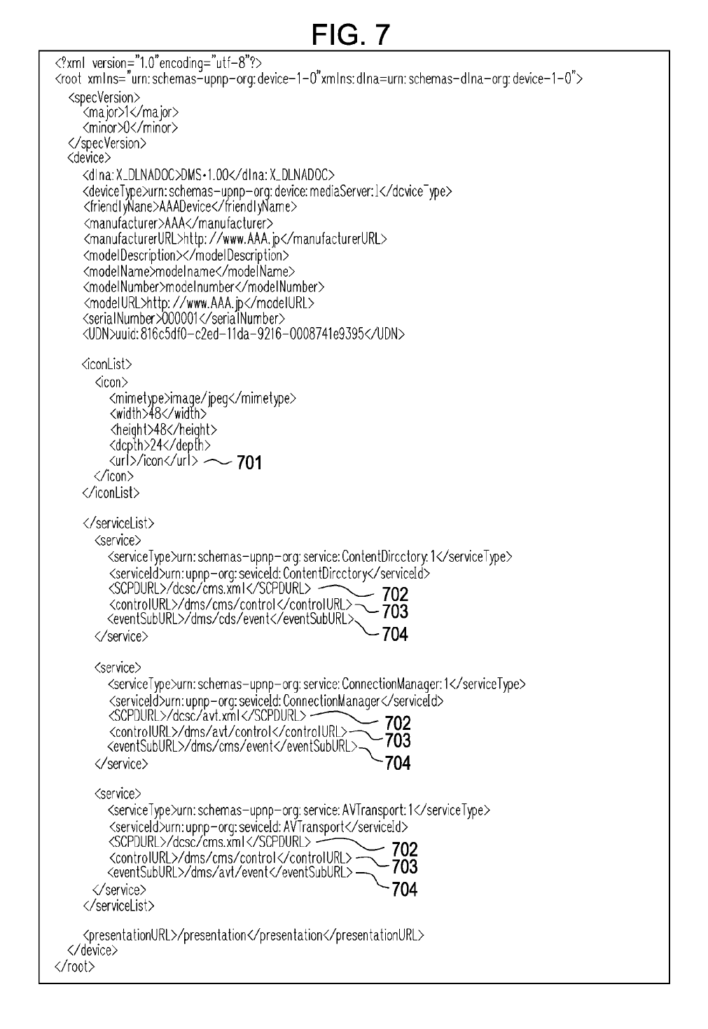

FIG. 7 is an illustration showing an example of the device description that the filter-information generating section 303 obtains. In step S407, the filter-information generating section 303 obtains a URL of an icon from a url tag 701 that is a sub-element of an icon tag, which is included in the obtained device description. Additionally, the filter-information generating section 303 obtains URLs of service descriptions from SCPDURL tags 702 that are sub-elements of service tags, which are included in the obtained device description. Furthermore, the filter-information generating section 303 obtains URLs for performing control from controlURL tags 703 that are sub-elements of the service tags, which are included in the obtained device description. Moreover, the filter-information generating section 303 obtains URLs for processing events from event SubURL tags 704 that are sub-elements of the service tags, which are included in the obtained device description.

In this embodiment, three services, ContentDirectory, ConnectionManager, and AVTransport, are provided. Filter information (filtering rules) is generated using the URL of the device description, the URL of an icon, the URLs of service descriptions of the respective services, the URLs for performing control for the respective services, and the URLs for processing events of the respective services. Furthermore, when the filter information is generated, a CACHE-CONTROL 601 that is included in the m-search response is also used.

The filter-information generating section 303 sends the generated filter information to the filter control section 302, and the process proceeds to step S408. As described above, the device description shown in FIG. 7 includes information showing an access destination of a UPnP device (function) that is included in the service providing apparatus 104.

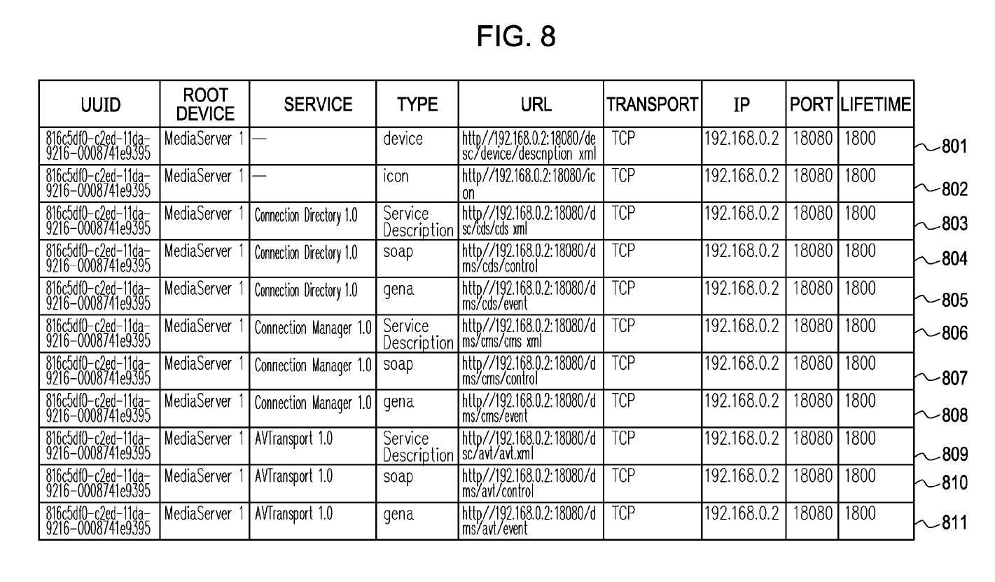

FIG. 8 is an illustration showing an example of the filter information (the filtering rules) that the filter-information generating section 303 has generated.

Referring to FIG. 8, a record 801 is generated using the URL of the device description, the CACHE-CONTROL 601, and so forth. A record 802 is generated using the URL of an icon, the CACHE-CONTROL 601, and so forth. Records 803, 806, and 809 are generated using the URLs of service descriptions of the corresponding services, the CACHE-CONTROL 601, and so forth. Records 804, 807, and 810 are generated using the URLs for performing control for the corresponding services, the CACHE-CONTROL 601, and so forth. Records 805, 808, and 811 are generated using the URLs for processing events of the corresponding services, the CACHE-CONTROL 601, and so forth.

Note that the filter information shown in FIG. 8 is information for limiting access to the UPnP device (function) that is included in the service providing apparatus 104.

In step S408, the filter control section 302 adds the filter information, which has been generated by the filter-information generating section 303, as an entry, and the process proceeds to step S410.

In step S409, the filter control section 302 updates a lifetime of a corresponding entry by using the CACHE-CONTROL 601 included in the m-search response. When an IP address or a port number has been changed, the filter control section 302 changes a corresponding description in the entry, and the process proceeds to step S410.

In step S410, the filter control section 302 sends the filter information as an entry to the filtering performing section 304. The filter control section 302 requests the filtering performing section 304 to start filtering, and the process ends. The filtering performing section 304 limits transfer so that a packet that is to be transferred to any one of the URLs included in the filter information which has received from the filter control section 302 is not transferred to the physical network (the LAN 101a).

In this embodiment, access to a URL is performed using a hypertext transfer protocol (HTTP). For example, a case is described, in which use of a GET message in the HTTP is limited. The filtering performing section 304 analyses HTTP communication to an access destination whose IP address is 192.168.0.2 and whose port number is 18080. When a message such as GET/desc/device/description.xml HTTP/1.1 exists, the filtering performing section 304 performs matching of the massage with the filter information shown in FIG. 8, and controls HTTP communication so that a packet is not transferred to the LAN 101a.

Here, the process that is performed in which the logical-network control apparatus 103a has received the logical-network connection request is described. However, the process illustrated in FIG. 4 may be performed before the logical-network control apparatus 103a connects to a logical network. In other words, the process may be performed in a case in which the logical-network control apparatus 103a sends the logical-network connection request to the other logical-network control apparatus, and the method for connecting to a logical network is not limited thereto.

In this embodiment, the UPnP device name is used in the method for searching a UPnP device by using an m-search. The UUID or the like may be used in the method, and the method for searching a UPnP device by using an m-search is not limited thereto.

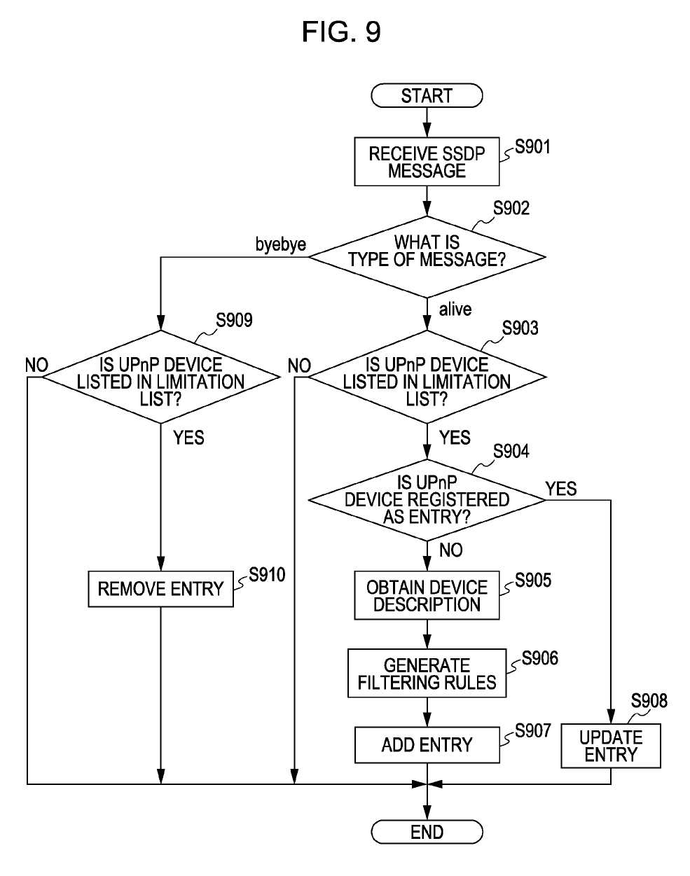

FIG. 9 is a flowchart illustrating a process that is performed in a case in which the logical-network control apparatus 103a has received an SSDP message (advertisement information for notifying that a function exists).

In step S901, when the service providing apparatus 104, which is connected on the LAN 101a, sends an SSDP message, the filter control section 302 receives the SSDP message via the TCP/IP control section 300, and the process proceeds to step S902.

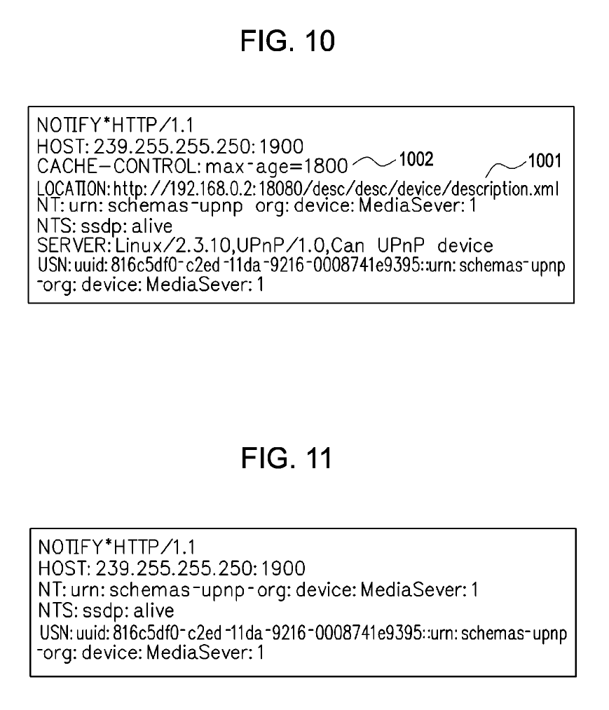

In step S902, the filter control section 302 determines the type of received SSDP message. When the filter control section 302 determines that the type of received SSDP message is an alive SSDP message, the process proceeds to step S903. FIG. 10 is an illustration showing an example of the alive SSDP message. In contrast, when the filter control section 302 determines that the type of received SSDP message is a byebye SSDP message, the process proceeds to step S909. FIG. 11 is an illustration showing an example of the byebye SSDP message.

Note that that the alive SSDP message is a message (existence information) for notifying from a UPnP device side that the UPnP device exists on a network, and that the byebye SSDP message is a message for notifying from a UPnP device side that the UPnP device will disappear from a network.

In step S903, the filter control section 302 determines whether or not the received alive SSDP message is an alive SSDP message that has been sent from a UPnP device which is listed in the limitation list. When it is determined that the received alive SSDP message is an alive SSDP message which has been sent from a UPnP device that is listed in the limitation list, the process proceeds to step S904. In contrast, when it is determined that the received alive SSDP message is not an alive SSDP message which has been sent from a UPnP device that is listed in the limitation list, the process ends. Also when there is no limitation list, the process ends.

In step S904, the filter control section 302 determines whether or not information corresponding to information that is included in the alive SSDP message has been registered as an entry in the filter information. When it is determined that information corresponding to information that is included in the alive SSDP message has been registered as an entry in the filter information, the filter control section 302 sends the information that is included in the alive SSDP message to the filter-information generating section 303, and the process proceeds to step S908. It is determined that information corresponding to information that is included in the alive SSDP message has not been registered as an entry in the filter information, the filter control section 302 sends the information that is included in the alive SSDP message to the filter-information generating section 303, and the process proceeds to step S905.

In step S905, the filter-information generating section 303 obtains a LOCATION value from the information that is included in the alive SSDP message. The LOCATION value (denoted by 1001 in FIG. 10) indicates a URL of a device description of a UPnP root device. The filter-information generating section 303 obtains the device description that is given at the URL via the TCP/IP control section 300, and the process proceeds to step S906. The configuration of the device description that the filter-information generating section 303 obtains is similar to that of the device description shown in FIG. 7.

In step S906, the filter-information generating section 303 obtains a URL of an icon from a url tag that is a sub-element of an icon tag, which is included in the obtained device description. The filter-information generating section 303 obtains URLs of service descriptions from SCPDURL tags that are sub-elements of service tags, which are included in the obtained device description. Furthermore, the filter-information generating section 303 obtains URLs for performing control from controlURL tags that are sub-elements of the service tags, which are included in the obtained device description. Moreover, the filter-information generating section 303 obtains URLs for processing events from eventSubURL tags that are sub-elements of the service tags, which are included in the obtained device description.

In this embodiment, three services, ContentDirectory, ConnectionManager, and AVTransport, are provided. Filter information is generated using the URL of the device description, the URL of an icon, the URLs of service descriptions of the respective services, the URLs for performing control for the respective services, and the URLs for processing events of the respective services. Furthermore, when the filter information is generated, a CACHE-CONTROL that is included in the alive SSDP message is also used.

The filter-information generating section 303 sends the generated filter information to the filter control section 302, and the process proceeds to step S907. The configuration of the filter information that is generated by the filter-information generating section 303 is similar to that of the filter information shown in FIG. 8.

In step S907, the filter control section 302 adds the filter information that has been generated by the filter-information generating section 303 as an entry, and the process ends.

In step S908, the filter control section 302 updates a lifetime (an existence period) by using a CACHE-CONTROL (denoted by 1002 in FIG. 10) in an entry corresponding to the alive SSDP message. When an IP address or a port number has been changed, the filter control section 302 changes a corresponding description in the entry, and the process ends. When an IP address or a port number is changed and filtering has been performed, the filter control section 302 requests the filtering performing section 304 to cancel filtering that has been performed before it is changed, and to perform filtering after it is changed.

In step S909, the filter control section 302 determines whether or not the byebye SSDP message is a byebye SSDP message that has been sent from a UPnP device which is listed in the limitation list. When it is determined that the byebye SSDP message is a byebye SSDP message which has been sent from a UPnP device that is listed in the limitation list, the process proceeds to step S910. In contrast, when it is determined that the byebye SSDP message is not a byebye SSDP message which has been sent from a UPnP device that is listed in the limitation list, the process ends. Furthermore, also when there is no limitation list, the process ends.

In step S910, the filter control section 302 removes information associated with the byebye SSDP message from entries in the filter information, and the process ends. Because the byebye SSDP message includes a UUID, the information associated with the byebye SSDP message can be removed from the entries at one time.

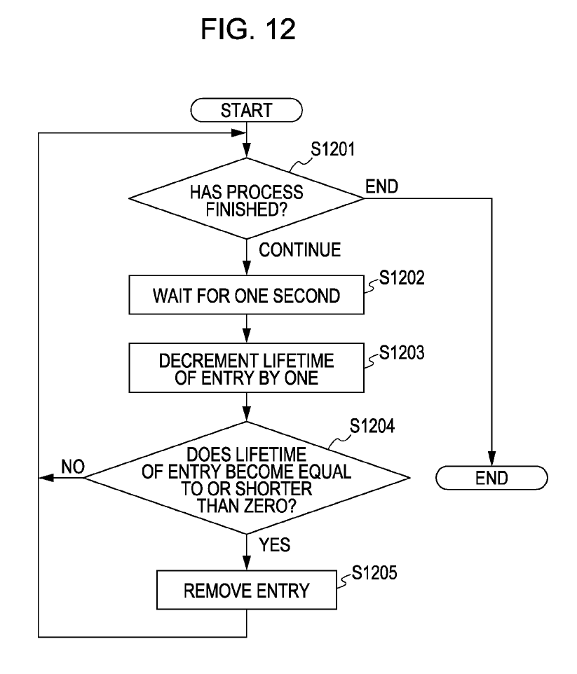

FIG. 12 is a flowchart illustrating a process that is performed while a process that started when the filter control section 302 was activated is continuing.

In step S1201, the filter control section 302 determines whether or not the completion of a process is accepted. When it is determined that the completion of a process is accepted, the process ends. In contrast, it is determined that the completion of a process is not accepted, the process proceeds to step S1202.

In step S1202, the filter control section 302 waits for one second, and the process proceeds to step S1203.

In step S1203, the filter control section 302 decrements a lifetime of an entry in the filter information by one, and the process proceeds to step S1204.

In step S1204, the filter control section 302 determines whether or not an entry whose lifetime is equal to or shorter than zero is included in the filter information. When it is determined that an entry whose lifetime is equal to or shorter than zero is included in the filter information, the process proceeds to step S1205. In contrast, when it is determined that no entry whose lifetime is equal to or shorter than zero is included in the filter information, the process proceeds to step S1201.

In step S1205, the filter control section 302 removes the entry whose lifetime is equal to or shorter than zero from the filter information, and the process proceeds to step S1201.

As described above, in this embodiment, when time exceeds a lifetime that is generated in step S906 shown in FIG. 9 or updated in step S908 shown in FIG. 9, an entry having the lifetime is removed.

As described above, in this embodiment, filter information can be generated using device descriptions of UPnP devices to which access limitations are to be imposed, and access can be easily limited on a UPnP-device-by-UPnP-device basis. For example, access to only a media server from among UPnP devices that are included in the same service providing apparatus 104 can be easily limited.

Furthermore, in this embodiment, a UPnP device to which an access limitation is to be imposed is searched. When an m-search response, which includes information as a response to a search, is received, filter information for limiting access to the UPnP device is dynamically generated. Accordingly, in this embodiment, filtering is performed only when the UPnP device exists on a network. Thus, filtering is not unnecessarily performed, and computational complexity can be decreased.

Moreover, in the related art, there was a high probability that an IP address was to be changed in an environment in which the IP address was assigned using dynamic host configuration protocol (DHCP) or the like, and it was necessary to reset a filter setting every time the IP address was changed. However, in this embodiment, filter control is performed when communication using UPnP with VPN connection in Layer 2 is performed, and this can cope with even a case in which an IP address is changed. Consequently, convenience to users is increased, and secure use can be realized.

Each unit and each step that are provided in the above-described embodiment of the present invention can be realized by executing a program that is stored in a RAM or ROM or the like of the computer. In another embodiment of the present invention, the program and a computer-readable recording medium in which the program is recorded are provided.

Furthermore, the present invention can be implemented as other embodiments in various forms, such as a system, a device, a method, a program, and a recording medium. More specifically, the present invention can be applied to an apparatus that is configured using a single device.

In another embodiment of the present invention, a software program for realizing functions of the above-described embodiment may be directly or remotely supplied to a system or a device. A computer of the system or the device reads a program code of the supplied program, and executes the program code, thereby also achieving the present invention.

Thus, in order to realize functions and processes of the above-described embodiment of the present invention with the computer, the program code that is installed into the computer may realize the present invention. In other words, the program for realizing the functions and processes of the embodiment of the present invention may be provided according to another embodiment. In such a case, the form of the program, such as object code, a program that is executed by an interpreter, or script data that is to be supplied to an operation system (OS), does not matter as long as the program has the functions.

Additionally, the computer executes the read program, thereby realizing the functions of the above-described embodiment. Moreover, an OS that operates on the computer or the like may practically perform some of or all of the processes in accordance with instructions of the program. The functions of the above-described embodiment can be realized through the processes.

Furthermore, in another embodiment, the program that is read from the recording medium may be written into a memory that is provided on a functionally expanded board which is inserted into the computer, or that is provided in a functionally expanded unit which is connected to the computer. A CPU that is provided on the functionally expanded board or in the functionally expanded unit or the like may practically perform some of or all of the processes in accordance with instructions of the program. The functions of the above-described embodiment can be realized through the processes.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-096292 filed Apr. 2, 2008, which is hereby incorporated by reference herein in its entirety.

What is claimed is:

1. A connection apparatus that is connected to a first network, the connection apparatus comprising:
a transfer section configured to transfer a signal between the first network and a second network;
an obtaining section configured to obtain function information from an apparatus that exists in the first network; and
a limiting section configured to limit signal transfer between the first network and the second network in accordance with destination information that is included in the function information obtained by the obtaining section.

2. The connection apparatus according to claim 1, wherein the obtaining section includes a selection unit configured to select a function in which a limitation on signal transfer is to be imposed by the limiting section, and obtains function information concerning the selected function.

3. The connection apparatus according to claim 1, wherein the limiting section limits signal transfer between the first network and the second network in accordance with the destination information for controlling a function, the destination information being included in the function information obtained by the obtaining section.

4. The connection apparatus according to claim 1, wherein, when the obtaining section receives a message indicating that a function exists, the obtaining section obtains the function information from a destination that is described in second destination information included in the message.

5. The connection apparatus according to claim 1, wherein the obtaining section includes a selection unit configured to select a function in which a limitation on signal transfer is to be imposed by the limiting section, and, when the obtaining section receives a message indicating that the selected function exists, the obtaining section obtains the function information from a destination that is described in second destination information included in the message.

6. The connection apparatus according to claim 1, wherein the limiting section limits signal transfer for communication between an apparatus that exists in a third network and the apparatus that exists in the first network in accordance with the destination information that is included in the function information obtained by the obtaining section, the third network being connected to the second network.

7. A method for limiting signal transfer using a connection apparatus that is connected to a first network, the method comprising:
obtaining function information from an apparatus that exists in the first network; and
limiting signal transfer between the first network and a second network in accordance with destination information that is included in the obtained function information.

8. The method according to claim 7, wherein the obtaining step includes selecting a function in which a limitation on signal transfer is to be imposed in the limiting step, and obtaining function information concerning the selected function.

9. The method according to claim 7, wherein, in the limiting step, signal transfer between the first network and the second network is limited in accordance with the destination information for controlling a function, the destination information being included in the obtained function information.

10. The method according to claim 7, wherein, in the obtaining step, when a message indicating that a function exists is received, the function information is obtained from a destination that is described in second destination information included in the message.

11. The method according to claim 7, wherein the obtaining step includes selecting a function in which a limitation on signal transfer is to be imposed in the limiting step, and when a message indicating that the selected function exists is received, obtaining the function information from a destination that is described in second destination information included in the message.

12. The method according to claim 7, wherein, in the limiting step, signal transfer for communication between an apparatus that exists in a third network and the apparatus that exists in the first network is limited in accordance with the destination information that is included in the function information obtained in the obtaining section, the third network being connected to the second network.

13. A computer readable storage medium containing computer-executable instructions for a connection apparatus that is connected to a first network, the medium comprising:
computer-executable instructions that obtain function information from an apparatus that exists in the first network; and
computer-executable instructions that limit signal transfer between the first network and a second network in accordance with destination information that is included in the obtained function information.

14. The storage medium according to claim 13, wherein the computer-executable instructions that obtain function information include computer-executable instructions that select a function in which a limitation on signal transfer is to be imposed, and computer-executable instructions that obtain function information concerning the selected function.

15. The storage medium according to claim 13, wherein, in the computer-executable instructions that limit signal transfer include computer-executable instructions that limit signal transfer between the first network and the second network in accordance with the destination information for controlling a function, the destination information being included in the obtained function information.

16. The storage medium according to claim 13, wherein, in the computer-executable instructions that obtain function information, include computer-executable instructions that when a message indicating that a function exists is received, the function information is obtained from a destination that is described in second destination information included in the message.

17. The storage medium according to claim 13, wherein the computer-executable instructions that obtain function information include computer-executable instructions that select a function in which a limitation on signal transfer is to be imposed, and computer-executable instructions that, when a message indicating that the selected function exists is received, obtain the function information from a destination that is described in second destination information included in the message.

18. The storage medium according to claim 13, wherein, in the computer-executable instructions that limit signal transfer, signal transfer for communication between an apparatus that exists in a third network and the apparatus that exists in the first network is limited in accordance with the destination information that is included in the function information which has been obtained in the obtaining section, the third network being connected to the second network.
